(19) United States
(12) Patent Application Publication
(10) Pub. No.: US 2017/0214847 A1
(43) Pub. Date: Jul. 27, 2017

(54) Method for Setting Shooting Parameters of HDR mode and Electronic Device Using the Same

(71) Applicant: Top Victory Investments Ltd., Kowloon (HK)

(72) Inventor: Tim Wu, New Taipei City (TW)

(21) Appl. No.: 15/003,839

(22) Filed: Jan. 22, 2016

(51) Int. Cl. H04N 5/232; G06F 1/16; G06F 3/0484

(52) U.S. Cl. CPC H04N 5/23216; G06F 3/04847; G06F 1/163

(57) ABSTRACT

A method for setting shooting parameters of a HDR mode includes: displaying a user interface provided for a user to set a shooting number of photographs consecutively taken at different exposures each time the user shoots in the HDR mode; when the user shoots in the HDR mode, detecting a vibration extent to determine whether to automatically increase the shooting number; uploading the photographs to a cloud server to perform a big-data or elite-data analysis to generate proposals for HDR image processing; and, according to the proposal selected by the user, performing the HDR image processing for the photographs to generate a HDR photograph.

### BACKGROUND OF THE INVENTION

1. Field of the Invention

The present invention relates to a method for setting shooting parameters and, more particularly, to a method for setting shooting parameters of a high-dynamic-range (HDR) mode and an electronic device using the same.

2. Description of the Prior Art

Electronic devices, such as mobile devices, wearable devices, or display devices, have become more and more technically advanced and multifunctional. For example, most current smartphones have a built-in digital camera to provide an image capture capability. Moreover, a shooting mode called HDR mode is becoming popular on electronic is devices capable of image capture, such as smartphones having a built-in digital camera because it permits the photographer to capture a greater range of tonal detail than the camera is capable of capturing in a single photograph. In a conventional HDR mode, cameras automatically take a predetermined shooting number (typically three) of consecutive photographs at different predetermined exposures (typically normal (0EV), under (−2EV), and over (+2EV) exposures) each time the photographer shoots. Then, smartphones combine the photographs using a predetermined proposal for HDR image processing to generate a HDR image.

### SUMMARY OF THE INVENTION

The present invention is adapted to providing a method for setting shooting parameters of a HDR mode and an electronic device using the same, which may provide more shooting parameters to set and more functions to operate in the HDR mode to provide a more flexible HDR mode.

According to an aspect of the present invention, there is provided a method for setting shooting parameters of a HDR mode. The method includes: displaying a user interface provided for a user to set a shooting number of photographs consecutively taken at different exposures each time the user shoots in the HDR mode; when the user shoots in the HDR mode, detecting a vibration extent to determine whether to automatically increase the shooting number; uploading the photographs to a cloud server to perform a big-data analysis or an elite-data analysis to generate proposals for HDR image processing; and, according to the proposal selected by the user, performing the HDR image processing for the photographs to generate a HDR photograph.

According to another aspect of the present invention, performing the big-data analysis may include: analyzing compositions of the photographs uploaded to the cloud server to determine a scene type; and, comparing the photographs with reference photographs of the same scene type, stored in the cloud server, to generate the proposals for the HDR image processing.

According to another aspect of the present invention, performing the elite-data analysis may include: analyzing compositions of the photographs uploaded to the cloud server to determine a scene type; and, comparing the photographs with award-winning photographs of the same scene type, stored in the cloud server, to generate the proposals for the HDR image processing.

According to another aspect of the present invention, the method may further include: uploading the proposal selected by the user and the HDR photograph to the cloud server.

According to another aspect of the present invention, the method may further include: displaying the user interface provided for the user to set an area performing the HDR image processing.

According to another aspect of the present invention, the method may further include: activating a camera facing the user to detect an eye pupil of the user to determine an interest area of the user; displaying a frame surrounding the interest area, provided for the user to zoom in or out to obtain the area; and, when the user finishes setting the area, performing the HDR image processing within the area.

According to another aspect of the present invention, there is provided an electronic device capable of image capture, using any one of the aforementioned methods.

According to another aspect of the present invention, the electronic device may be a mobile device, a wearable device, or a display device.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a flowchart of a method for setting shooting parameters of a HDR mode according to an embodiment of the present invention;

FIG. 2 is a flowchart of performing a big-data analysis according to an embodiment of the present invention;

FIG. 3 is a flowchart of performing an elite-data analysis according to an embodiment of the present invention; and

FIG. 4 is a flowchart of a method for setting shooting parameters of a HDR mode according to another embodiment of the present invention.

### DESCRIPTION OF THE PREFERRED EMBODIMENTS

Reference will now be made in detail to the present embodiments of the invention, examples of which are illustrated in the accompanying drawings. Wherever possible, the same reference numbers are used in the drawings and the description to refer to the same or like parts.

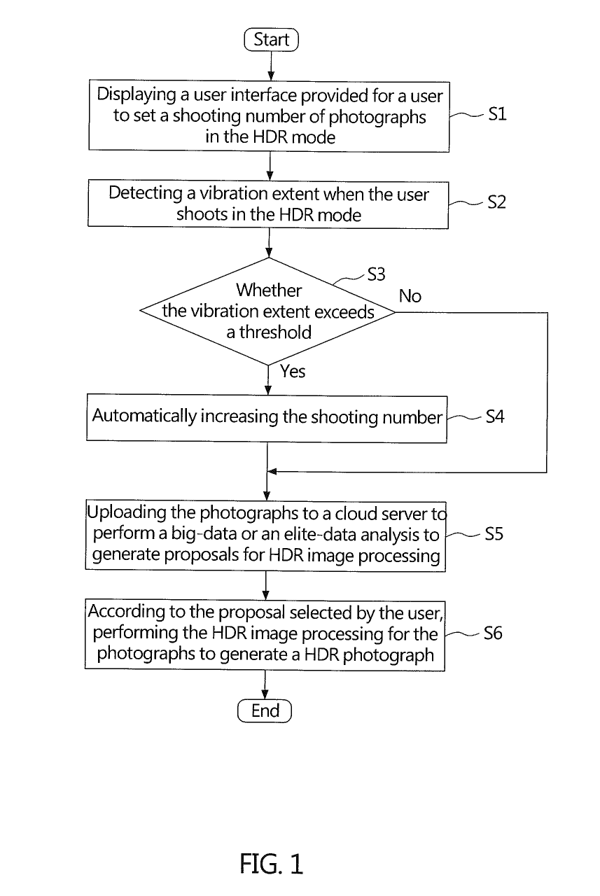

FIG. 1 is a flowchart of a method for setting shooting parameters of a HDR mode according to an embodiment of the present invention. Referring to FIG. 1, at step S1, a user interface is displayed on an electronic device capable of image capture, such as a mobile device, a wearable device, or a display device having a built-in digital camera. The user interface is provided for a user to set a shooting number of photographs consecutively taken at different exposures each time the user shoots in the HDR mode. For example, the shooting number may be set to two, three, or more by the user.

At step S2, when the user shoots in the HDR mode, the electronic device detects a vibration extent to determine whether to automatically increase the shooting number to reduce blurring associated with the motion of the electronic device that usually results from a hand shake of the user. Compared to the conventional HDR mode using the predetermined shooting number, the HDR mode according the embodiment of the present invention may provide the user to manually set the shooting number and automatically increase the shooting number to reduce the effect of the vibration.

At step S3, the electronic device determines whether the vibration extent exceeds a threshold or not. If the vibration extent exceeds the threshold, the procedure goes to step S4 and then to step S5; if the vibration extent does not exceed the threshold, the procedure directly goes to step S5.

At step S4, the electronic device automatically increases the shooting number. For example, if the shooting number set by the user is three and the exposures of the three photographs are automatically bracketed at 0EV, −2EV, and +2EV, then the shooting number automatically set by the electronic device due to the vibration may be five and the exposures of the five photographs are automatically bracketed at 0EV, −1EV, −2EV, +1EV, and +2EV. In an embodiment, the vibration extent exceeding the threshold may be further divided into three classes having different shooting numbers. For example, the shooting number automatically set by the electronic device due to the vibration may be five in the first class, seven in the second class, and nine in the third class.

At step S5, after the consecutive photographs are taken, the user interface may be displayed to provide the user to select whether to upload the photographs to a cloud server to perform a big-data analysis or an elite-data analysis to generate proposals for HDR image processing. If the user selects not to upload the photographs, the electronic device combines the photographs using a predetermined proposal for the HDR image processing to generate a HDR image, similar to the conventional HDR mode. If the user selects to upload the photographs, the cloud server performs the big-data or elite-data analysis on the photographs to generate the proposals for the HDR image processing and sends the proposals back to the electronic device.

At step S6, the user interface may be displayed to provide the user to select a specific proposal from the proposals sent from the cloud server. Then, the electronic device performs, according to the proposal selected by the user, the HDR image processing for the photographs to generate a HDR photograph. Compared to the conventional HDR mode using the predetermined proposal for the HDR image processing, the HDR mode according the embodiment of the present invention may provide the user to select a specific proposal for the HDR image processing from different proposals suggested from the cloud server and then perform, according to the specific proposal, the HDR image processing.

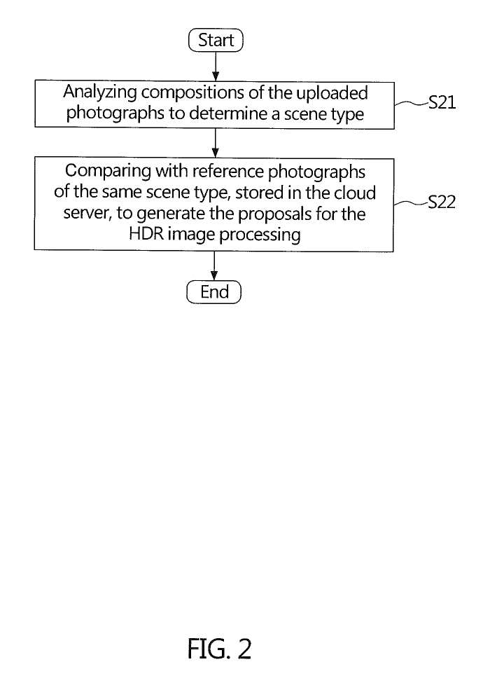

FIG. 2 is a flowchart of performing a big-data analysis according to an embodiment of the present invention. Referring to FIG. 2, at step S21, the cloud server analyzes compositions of the photographs uploaded to the cloud server to determine a scene type. At step S22, the cloud server compares the photographs with reference photographs of the same scene type, stored in the cloud server, to generate the proposals for the HDR image processing.

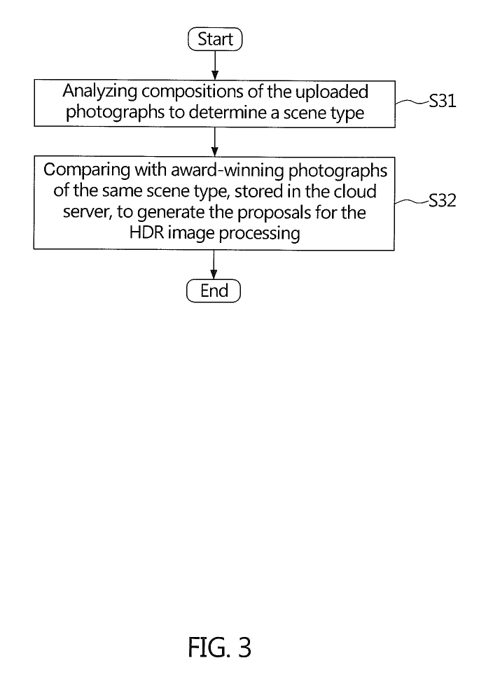

FIG. 3 is a flowchart of performing an elite-data analysis according to an embodiment of the present invention. Referring to FIG. 3, at step S31, the cloud server analyzes compositions of the photographs uploaded to the cloud server to determine a scene type. At step S32, the cloud server compares the photographs with award-winning photographs of the same scene type, stored in the cloud server, to generate the proposals for the HDR image processing.

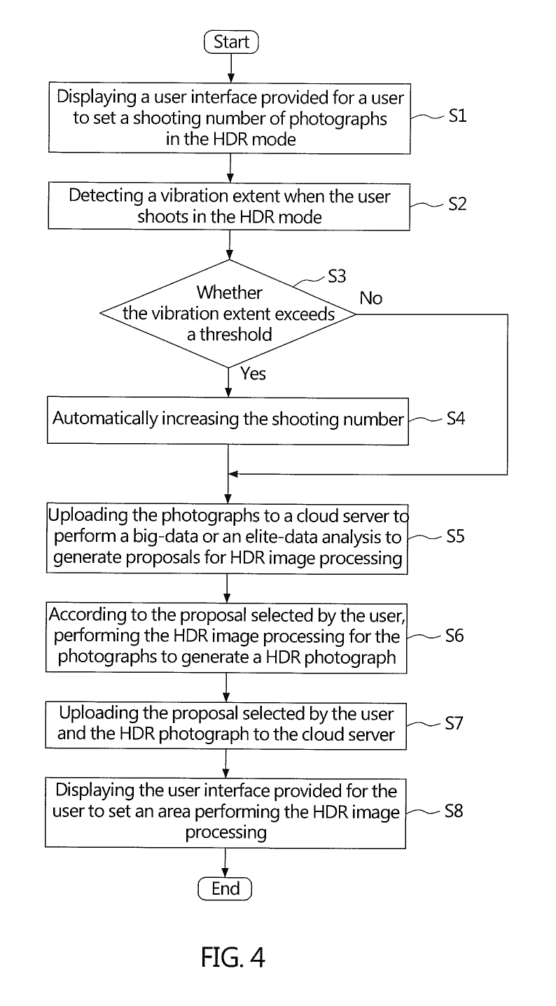

FIG. 4 is a flowchart of a method for setting shooting parameters of a HDR mode according to another embodiment of the present invention. Referring to FIG. 4, compared to the method shown in FIG. 1, the method in the embodiment further includes steps S7 and S8. At step S7, the user interface may be displayed to provide the user to select whether to upload the proposal selected by the user and the HDR photograph to the cloud server, in which the uploaded HDR photograph may be regarded as a reference photograph. In an embodiment, the cloud server may ask the user whether to submit the HDR photograph to participate in competition, in which the uploaded HDR photograph may be regarded as an award-winning photograph if winning some award in competition.

At step S8, the user interface may be displayed to provide the user to set an area performing the HDR image processing. In an embodiment, the user may set multiple areas performing the HDR image processing and apply different proposals for HDR image processing to different areas. For example, the user sets three areas and two different proposals, the first proposal applied to the first area and the second proposal applied to the second and third areas.

In an embodiment, if the electronic device has two cameras, one facing the user and the other facing a shot object, the electronic device may activate the camera facing the user to detect an eye pupil of the user to determine an interest area of the user. Then, the electronic device may display a frame surrounding the interest area, provided for the user to zoom in or out to obtain the area. Finally, when the user finishes setting the area, the electronic device may perform the HDR image processing within the area.

It will be apparent to those skilled in the art that various modifications and variations can be made to the structure of the present invention without departing from the scope or spirit of the present invention. In view of the foregoing, it is intended that the present invention cover modifications and variations of this invention provided they fall within the scope of the following claims and their equivalents.

What is claimed is:

1. A method for setting shooting parameters of a high-dynamic-range (HDR) mode, comprising:
displaying a user interface provided for a user to set a shooting number of photographs consecutively taken at different exposures each time the user shoots in the HDR mode;
when the user shoots in the HDR mode, detecting a vibration extent to determine whether to automatically increase the shooting number;
uploading the photographs to a cloud server to perform a big-data analysis or an elite-data analysis to generate proposals for HDR image processing; and
according to the proposal selected by the user, performing the HDR image processing for the photographs to generate a HDR photograph.

2. The method of claim 1, wherein performing the big-data analysis comprising:
analyzing compositions of the photographs uploaded to the cloud server to determine a scene type; and
comparing the photographs with reference photographs of the same scene type, stored in the cloud server, to generate the proposals for the HDR image processing.

3. The method of claim 1, wherein performing the elite-data analysis comprising:
analyzing compositions of the photographs uploaded to the cloud server to determine a scene type; and
comparing the photographs with award-winning photographs of the same scene type, stored in the cloud server, to generate the proposals for the HDR image processing.

4. The method of claim 1, further comprising:
uploading the proposal selected by the user and the HDR photograph to the cloud server.

5. The method of claim 1, further comprising:
displaying the user interface provided for the user to set an area performing the HDR image processing.

6. The method of claim 5, further comprising:
activating a camera facing the user to detect an eye pupil of the user to determine an interest area of the user;
displaying a frame surrounding the interest area, provided for the user to zoom in or out to obtain the area; and
when the user finishes setting the area, performing the HDR image processing within the area.

7. An electronic device capable of image capture, using the method of claim 1.

8. The electronic device of claim 7, comprising a mobile device.

9. The electronic device of claim 7, comprising a wearable device.

10. The electronic device of claim 7, comprising a display device.
